(19) United States
(12) Patent Application Publication
(10) Pub. No.: US 2026/0332544 A1
(43) Pub. Date: Oct. 22, 2026

(54) METHOD, SYSTEM AND PRODUCT FOR TRANSMITTING TELEMETRY DATA

(71) Applicant: DELL PRODUCTS L.P., ROUND ROCK, TX (US)

(72) Inventors: Ren Wang, Shanghai (CN); Mengze Liao, Shanghai (CN); Huifeng Li, Shanghai (CN); Weiyang Liu, Shanghai (CN); Yongbing Xue, Shanghai (CN)

(21) Appl. No.: 19/232,055

(22) Filed: Jun. 9, 2025

(30) Foreign Application Priority Data
Apr. 18, 2025 (CN) 202510495079.8

(51) Int. Cl. H04L 49/90; H04L 9/40; H04L 67/12

(52) U.S. Cl. CPC H04L 49/9036; H04L 63/0428; H04L 67/12

(57) ABSTRACT

Embodiments of the present disclosure relate to a method, system, and computer program product for transmitting telemetry data. The method includes receiving data from a client, where the data is used to monitor a status of the client. The method further includes classifying, based on a plurality of telemetry data types, the data into a plurality of buffer queues for the plurality of telemetry data types, and transmitting the classified telemetry data in parallel via the plurality of buffer queues for the plurality of telemetry data types. The method implemented by the present disclosure can establish separate data transmission channels for data of different resource types, and avoid interleaving of different types of data, thereby improving the transmission speed and efficiency, and reducing data loss and error rate.

### TECHNICAL FIELD

Embodiments of the present disclosure relate to the field of computers, and more particularly, to a method, system, and product for transmitting telemetry data.

### BACKGROUND

At present, enterprise development relies on data-driven insights. This requires a robust data collection system that collects information from various sources and reliably transmits the information to a central repository. With the development of technologies such as the Internet of Things, cloud computing, and edge computing, various devices and sensors constantly generate telemetry data, and the data may include system performance indicators, user behaviors, environmental monitoring, and other types. Distributed computing and storage architectures are used to handle highly concurrent data and large-scale storage requirements.

The telemetry technology has become a popular framework for measuring, producing, collecting, and outputting telemetry data. Through the telemetry technology, enterprises can maintain business operations, monitor system performance in real time, and optimize resource allocation, thereby providing early warning of system failures and security risk prompts.

### SUMMARY OF THE INVENTION

The embodiments of the present disclosure relate to a method, system, and product for transmitting telemetry data.

According to a first aspect of the present disclosure, a method for transmitting telemetry data is provided. The method includes receiving data from a client, where the data is used to monitor a status of the client. The method further includes classifying, based on a plurality of telemetry data types, the data into a plurality of buffer queues for the plurality of telemetry data types, and transmitting the classified telemetry data in parallel via the plurality of buffer queues for the plurality of telemetry data types.

According to a second aspect of the present disclosure, a system for transmitting telemetry data is provided. The system includes a processor; and a memory coupled to the processor and storing instructions, where the instructions, when executed by the processor, cause the system to perform actions including: receiving data from a client, where the data is used to monitor a status of the client. The actions further include classifying, based on a plurality of telemetry data types, the data into a plurality of buffer queues for the plurality of telemetry data types, and transmitting the classified telemetry data in parallel via the plurality of buffer queues for the plurality of telemetry data types.

According to a third aspect of the present disclosure, a computer program product is provided. The computer program product is tangibly stored on a non-volatile computer-readable medium and includes machine-executable instructions which, when executed, cause a machine to perform steps of the method implemented in the first aspect of the present disclosure.

### BRIEF DESCRIPTION OF THE DRAWINGS

The above and other objectives, features, and advantages of the present disclosure will become more apparent from more detailed description of example embodiments of the present disclosure with reference to the drawings, where in the example embodiments of the present disclosure, the same reference numerals generally represent the same elements.

FIG. 1A is a schematic diagram of some processes for transmitting telemetry data associated with an embodiment of the present disclosure;

FIG. 1B is a schematic diagram of some processes for transmitting telemetry data associated with an embodiment of the present disclosure;

FIG. 2 is a flow chart describing a process for transmitting telemetry data according to an embodiment of the present disclosure;

FIG. 3 is a schematic diagram of some processes for transmitting telemetry data according to an embodiment of the present disclosure; and

FIG. 4 is a schematic block diagram of an example device that can be used to implement an embodiment of the present disclosure.

### DETAILED DESCRIPTION

Example embodiments will be described more fully with reference to the accompanying drawings. However, example embodiments can be implemented in many forms and should not be construed as limited to the embodiments set forth herein; rather, these embodiments are provided so that the present application will be thorough and complete and will fully convey the concept of the example embodiments to those skilled in the art. The same reference numerals in the drawings denote the same or similar parts, and thus their repeated description will be omitted.

Furthermore, the described features, structures, or characteristics may be combined in any suitable manner in one or more embodiments. In the following description, numerous specific details are provided in order to give a thorough understanding of embodiments of the present application. However, those skilled in the art will appreciate that the technical solutions of the present application can be practiced without one or more of the specific details, or other methods, components, apparatuses, steps, and the like can be adopted. In other instances, well-known methods, apparatuses, implementations, or operations are not shown or described in detail to avoid obscuring aspects of the present application.

In the description of embodiments of the present disclosure, the term “including” and its variations should be understood as open-ended inclusion, i.e., “including but not limited to.” The term “based on” should be understood as “at least in part based on.” The term “an embodiment” or “the embodiment” should be understood as “at least one embodiment.” The terms first, second, third, and the like may be used herein to describe various components, but these components should not be limited by these terms. These terms are used to distinguish one component from another. Thus, a first component discussed below may be referred to as a second component without departing from the teachings of the concepts of the present application. As used herein, the term “and/or” and similar terms include all combinations of any one, more, and all of the associated listed items.

The blocks shown in the drawings are merely functional entities and do not necessarily correspond to physically separate entities. That is, these functional entities may be implemented in a software form, or implemented in one or more hardware modules or integrated circuits, or implemented in different networks and/or processor apparatuses and/or microcontroller apparatuses.

The flow charts shown in the drawings are merely example illustrations and do not necessarily include all contents and operations/steps, nor do they necessarily have to be performed in the order described. For example, some operations/steps may be decomposed, while some operations/steps may be combined or partially combined, so the actual performing order may change according to actual circumstances.

When telemetry data is currently transmitted through a telemetry pipeline, the telemetry data in the telemetry pipeline is interleaved and stacked on top of each other and sent to a downstream service component through a port. After receiving the telemetry data, the downstream service component needs to unpack and process the data one by one, and store the unpacked and processed data one by one. This results in inefficient transmission and, when a large amount of data is incoming, deadlock and data loss may occur.

At least to address the above and other potential problems, the embodiments of the present disclosure provide a method for determining a generative model. According to an embodiment of the present disclosure, data from a client may be received. A data collector implemented according to an embodiment of the present disclosure may collect a plurality of different types of data from different data pages of the client in parallel through a plurality of threads. According to an embodiment of the present disclosure, the data may further be classified, based on a plurality of telemetry data types, into a plurality of buffer queues for the plurality of telemetry data types. For example, the classified telemetry data may be sent to the plurality of buffer queues for caching. According to an embodiment of the present disclosure, the classified telemetry data may further be transmitted in parallel via the plurality of buffer queues for the plurality of telemetry data types.

The method implemented by the present disclosure can establish separate data transmission channels for data of different resource types (for example, activity and copy), and avoid interleaving of different types of data, thereby improving the transmission speed and efficiency, and reducing data loss and error rate.

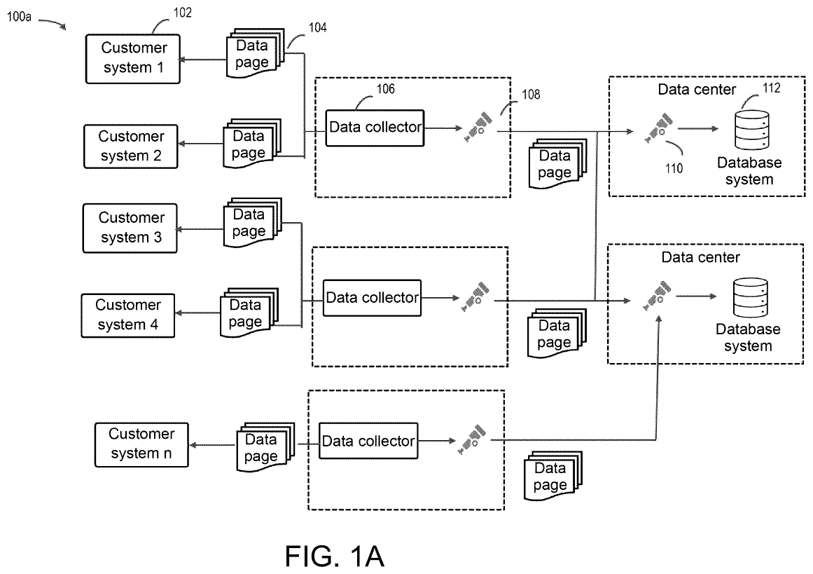

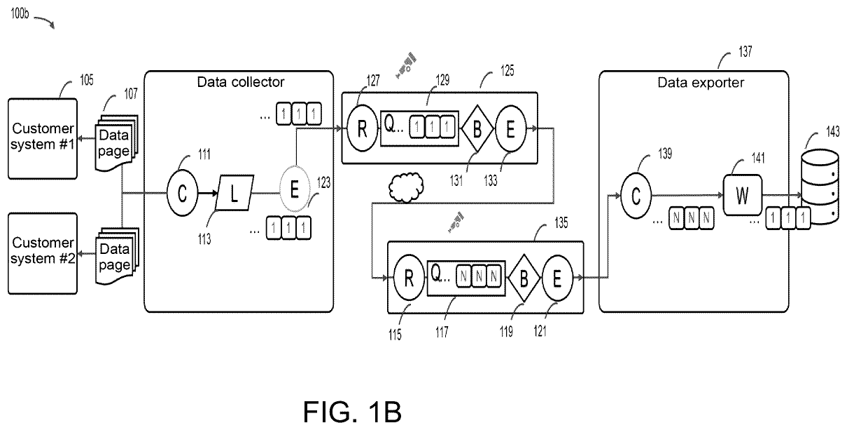

FIG. 1A is a schematic diagram of some processes 100a for transmitting telemetry data associated with an embodiment of the present disclosure. As shown in FIG. 1A, the environment may include a plurality of customer systems, such as a customer system 1 102, a customer system 2, a customer system 3, a customer system 4, . . . , and a customer system n. In some embodiments of the present disclosure, these customer systems may also be referred to as clients.

Each customer system or client represents a different business system or data source within an enterprise or company. According to some embodiments of the present disclosure, the customer system may be a system such as a computing system, a customer relationship management (CRM) system, a sales system, or an inventory management system. According to an embodiment of the present disclosure, the customer system or client may be implemented in a computing device. For example, the computing device may have common abilities, such as receiving and sending data requests, real-time data analysis, local data storage, and real-time network linkage. According to some embodiments of the present disclosure, the computing device may typically include various types of devices. Examples of the computing device may include but are not limited to: database servers, rack servers, server clusters, blade servers, enterprise servers, application servers, desktop computers, laptops, smartphones, wearable devices, security devices, intelligent manufacturing devices, smart home devices, Internet of Things devices, smart cars, drones, and so on, which is not limited in the present disclosure.

Each customer system in the plurality of systems may generate various types of business-related data, and the data may be stored or generated in a form of a data page 104, for example. According to some embodiments of the present disclosure, the data page 104 may include business information associated with the customer system. As an embodiment of the present disclosure, the data page 104 may include user behavior data, for example, access log data such as user access path, dwell time, click behavior, and page loading time, and user interaction events such as user click operations. According to some embodiments of the present disclosure, the data page 104 may also include system monitoring data such as CPU occupancy, disk usage, memory usage, network latency, bandwidth, system load, resource consumption, application logs, and error exception logs of the customer system. Additionally or alternatively, the data page 104 may also include business transaction data of the customer system such as order number and product information, production and inventory management data such as equipment operation data and production environment parameters, and sensor device data such as temperature, humidity, and pressure, and the present disclosure does not impose any restrictions on this.

According to some embodiments of the present disclosure, the data pages generated by each customer system of the plurality of customer systems may be collected and processed by a data collection program such as a data collector 106. In some embodiments, the data collector may be a lightweight program and deployed on a device or node where each customer system is located, for extracting data pages 104 from the customer system in real time or periodically. According to some embodiments of the present disclosure, the data collector 106 may collect data from different data sources such as a file system, a database, a business application, and a log file. According to an embodiment of the present disclosure, the data collector 106 may also pre-process the collected data, for example, perform preliminary filtering, data format conversion, normalization, and the like on the collected data.

According to some embodiments of the present disclosure, data collected by a data collection program such as the data collector 106 may be sent to a telemetry pipeline node 108 for processing and transmission to a back-end database. The connection between the data collector and the telemetry pipeline can be achieved through a data transmission protocol such as HTTP or TCP. According to some embodiments of the present disclosure, the telemetry pipeline node 108 may provide a data monitoring and telemetry data management framework, as well as standardized interfaces and tools, so as to implement data monitoring, processing, and exporting. For example, in some embodiments of the present disclosure, the telemetry pipeline node 108 may include module elements such as a data validation and filtering module, a data conversion and packetization module, and a data cache module.

As an example, the data validation and filtering module in the telemetry pipeline node 108 may perform integrity checks and preliminary processing on the collected data pages to remove invalid data and filter out redundant data. In some embodiments, the data cache module in the telemetry pipeline node 108 may also cache the collected data to reduce the network transmission burden and improve the data processing efficiency. Additionally or alternatively, in some embodiments, the data conversion and packetization module in the telemetry pipeline node 108 may further perform batch processing operations such as compression, data aggregation, and data packetization on the processed data, thereby batch-processing the collected data pages.

After the collected data pages are processed, the processed data pages can be transmitted in a compressed format or a standardized data format to another telemetry pipeline node 110 located in the data center for reception, and stored in a data system 112 such as the data center for further analysis and processing. According to the embodiments of the present disclosure, the back-end system of the data center can utilize the centralized data to further perform in-depth data analysis, user behavior prediction, or market trend analysis, thereby generating specific business insights and decision-making basis.

FIG. 1B is a schematic diagram of some processes 100b for transmitting telemetry data associated with an embodiment of the present disclosure. According to an embodiment of the present disclosure, a plurality of customer systems, such as a customer system 105, can store business data as well as resource data. By way of example, such data may include, but is not limited to, user activity data such as user activity logs and event records, replication data for backup records and data copies, and the like. Additionally or alternatively, according to some embodiments of the present disclosure, the user activity data may include fields such as user behavior, timestamp, and device information, and a data structure of the user activity data may be recorded in a manner of JSON, XML, a relational table, or the like. Additionally or alternatively, according to some embodiments of the present disclosure, the replication data may record file metadata information such as file replication, version control, or data snapshots associated with files. According to some embodiments of the present disclosure, the replication data may also include information such as status and error code.

According to some embodiments of the present disclosure, each type of data in the business data and resource data may be stored in the form of data pages 107. For example, each data page may be composed of several entries, and the entries may be paged in fixed sizes. As an example, each data page may be composed of 512 entries. The entry value may be configured according to different systems to avoid memory overflow or transmission delay caused by loading all data at once. For example, the value is adjusted to 200 or 1000 entries per page according to the data volume, so as to improve the network transmission efficiency and reduce the system pressure.

According to some embodiments of the present disclosure, the data collector may be configured to collect data pages 107 generated by the customer system. As an example, a data collection controller 111 in the data collector may trigger a collection action at regular intervals (for example, every 10 minutes or a shorter time) according to a time period, poll various types of resources in each customer data system, and perform page-by-page crawling and collection. According to some embodiments of the present disclosure, the data collection controller 111 may periodically issue a collection task through, for example, a timer. Additionally or alternatively, in some embodiments, the data collection controller 111 may assign independent tasks to each customer system and each resource type, so that a plurality of tasks do not interfere with each other.

Specifically, according to some embodiments of the present disclosure, the data collection controller 111 may utilize a thread pool to process in parallel paged collection operations of different resource types or the same customer system. For example, in one embodiment of the present disclosure, each thread of a plurality of threads in the thread pool in the data collection controller 111 can independently load a paged collection. Additionally or alternatively, when a thread fails to successfully collect data pages due to network interruption or timeout, the thread may perform recollection within a predetermined time interval and perform error logging for subsequent monitoring and improvement.

According to some embodiments of the present disclosure, after the data collection controller 111 collects the data pages 107, a logback appender 113 in the data collector may convert the collected data pages 107 into a structured backtrace log format. According to some embodiments of the present disclosure, the backtrace log may encapsulate key information, such as data type, collection time, data content, customer ID, and paging number in, for example, a JSON format. Additionally or alternatively, in some embodiments of the present disclosure, the backtrace log may also include metadata information such as a source identifier, a data offset, a page number, and a thread ID for subsequent check. The logback appender 113 can convert data of different threads and different types into a unified “log” format for subsequent processing.

According to some embodiments of the present disclosure, after the logback appender 113 performs format conversion on the collected data pages 107 to obtain backtrace logs, an exporter 123 in the data collector may further process the backtrace logs. In some embodiments of the present disclosure, the exporter 123 may temporarily cache the received log data in an internal cache queue, and maintain the order in the queue through a first-in-first-out (FIFO) mechanism for subsequent batch processing. According to some embodiments of the present disclosure, the exporter 123 may then send the log data in the queue to a local telemetry pipeline node 125 via a corresponding telemetry port through a transport protocol such as OTLP or gRPC/HTTP.

According to some embodiments of the present disclosure, the telemetry pipeline node 125 may include a corresponding receiver 127, which is configured to receive log or metric data from the upstream exporter 123 via a corresponding telemetry port through a transport protocol such as OTLP or gRPC/HTTP. In some embodiments of the present disclosure, the receiver 127 in the telemetry pipeline node 125 may further decode or parse the received data stream and generate a data format applicable to the telemetry pipeline node 125. According to some embodiments of the present disclosure, the telemetry pipeline node 125 may further include a queue 129 for caching received data. According to some embodiments of the present disclosure, the queue 129 may cache the received data in a first-in-first-out manner.

According to some embodiments of the present disclosure, the telemetry pipeline node 125 may further include a batch processor 131. The batch processor 131 may be configured to subsequently perform a packetization batch-processing operation on the cached log data. For example, in one embodiment, the batch processor in the telemetry pipeline node 125 may periodically extract a certain number of pieces of data from the cached queue 129. For example, in one embodiment, when the data in the cached queue 129 reaches a preset number (for example, 1000 pieces), the batch processor may initiate a packetization operation. Additionally or alternatively, when the waiting time exceeds a set time (for example, 1 second), the batch processor 131 may initiate a packetization operation regardless of the volume of data in the queue. According to some embodiments of the present disclosure, if the size of packets in the queue is different from the size of the batch to be packetized, the batch may be re-packetized and then distributed. Since different types of data may be sent in an interleaved manner, the batch includes interleaved and mixed data, and each packet may not contain the same type of data.

According to some embodiments of the present disclosure, the packetized log data may include data of different data types or sources. In some embodiments, the data may be provided with identifiers for subsequent unpacking and classification. According to an embodiment of the present disclosure, the telemetry pipeline node 125 may further include an exporter 133, which may be configured to send the packetized data to the next telemetry pipeline node 135. A connection may be connected between the telemetry pipeline node 125 and the next telemetry pipeline node 135 via OTLP or other standard network transmission protocols, and the two can be deployed between different servers or geographical regions. The data transmission between the telemetry pipeline node 125 and the next telemetry pipeline node 135 may cross servers, cross data centers, or even cross geographical regions.

According to some embodiments of the present disclosure, the telemetry pipeline node 135 may be located in an independent or remote data center for further processing of the data. According to some embodiments of the present disclosure, the telemetry pipeline node 135 may have the same or corresponding architecture and the same or corresponding elements as the telemetry pipeline node 125, such as a receiver 115, a queue 117, a batch processor 119, and an exporter 121, and corresponding steps, which will not be repeated in the present disclosure.

According to some embodiments of the present disclosure, the data center may further include a data exporter 137. The data exporter 137 may be a lightweight data output service and is configured to ultimately write the data from the telemetry pipeline node 135 into a database in the data center. According to some embodiments of the present disclosure, the data exporter 137 may include a controller 139, and the controller 139 may be configured to batched data packets transmitted from the telemetry pipeline node 135.

For example, as an example, in some embodiments of the present disclosure, the controller 139 may divide the batched data packets into a single or a plurality of smaller packets to identify data of different data types, such as user activity data and replication data. In some embodiments, the controller 139 may also perform data filtering or verification on the unpacked data, for example, performing a data integrity check. Additionally or alternatively, in some embodiments of the present disclosure, the controller 139 may further perform data aggregation or further division on the unpacked data, for example, aggregating data of the same type, further dividing the data according to user-predetermined rules, or the like.

According to some embodiments of the present disclosure, the data center may further include a writer 141, and the writer may be configured to receive the divided data for writing, such as writing the processed activity entities or replication entities into corresponding fields of a data table in a database 143 of the data center to achieve data persistence. In some embodiments, concurrent writing can also be performed to improve the writing efficiency. Additionally or alternatively, in some embodiments, the write speed may also be controlled by an auxiliary hibernation setting. The method implemented by the present disclosure can realize operations such as real-time data analysis and business monitoring.

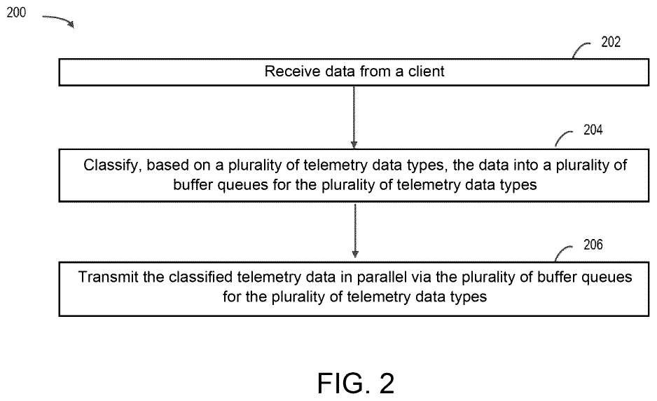

A schematic diagram of a process according to an embodiment of the present disclosure has been described above with reference to FIG. 1A to FIG. 1B. A flow chart of a process 200 for transmitting telemetry data according to an embodiment of the present disclosure will be described below with reference to FIG. 2.

As shown in FIG. 2, at a block 202, data from a client is received. According to some embodiments of the present disclosure, a data collector may collect data, such as system logs, performance indicators, operating system feedback, or software crash reports, user activity data, replication data, and other business data, from the client or a customer system in parallel through a plurality of threads. In some embodiments, the data may be collected in a form of entries in data pages.

At a block 204, data is classified, based on a plurality of telemetry data types, into a plurality of buffer queues for the plurality of telemetry data types. According to some embodiments of the present disclosure, a logback appender may send the collected data to corresponding cache queues through a plurality of send ports based on the plurality of telemetry data types.

As an example, the telemetry data types may include, but are not limited to, user activity data types, replication data types, and other business data types. According to some embodiments of the present disclosure, the corresponding cache queues may include a cache queue for user activity data, a cache queue for replication data, a cache queue for other business data, and the like.

At a block 206, the classified telemetry data is transmitted in parallel via the plurality of buffer queues for the plurality of telemetry data types. According to an embodiment of the present disclosure, the data collector may first encapsulate the classified telemetry data, and then transmit the classified telemetry data to downstream components via the plurality of buffer queues, such as transmitting the corresponding telemetry data to one or more downstream telemetry pipelines and a database in a corresponding data center.

The method implemented by the present disclosure can avoid a plurality of different types of data occupying the same buffer queue, realize dedicated transmission of different data, improve the transmission efficiency and speed, and reduce the error rate and data loss that may occur during the transmission process.

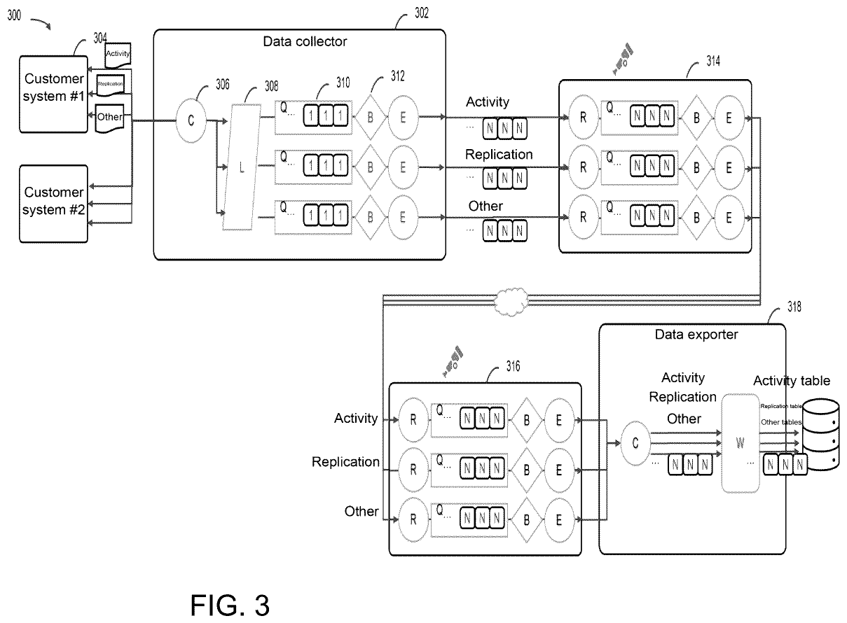

FIG. 3 is a schematic diagram of some processes 300 for transmitting telemetry data according to an embodiment of the present disclosure. As shown, a data collector 302 may receive data from, for example, a customer system 304. For example, in some embodiments of the present disclosure, the data collector 302 may first acquire data based on data pages (for example, 512 pieces of data per page). Specifically, in some embodiments, the data collector 302 may utilize a thread pool to perform concurrent collection on data pages of different data sources or different types. In some embodiments of the present disclosure, the data collector 302 may allocate a dedicated thread for each resource type to ensure that each thread independently completes the collection of corresponding page data, so as to avoid affecting the overall collection efficiency due to the blocking of a single thread.

For example, according to some embodiments of the present disclosure, after collecting one or a plurality of data pages, a controller 306 in the data collector 302 implemented according to some embodiments of the present disclosure can perform preliminary parsing on the data to identify a resource type corresponding to each data record, such as “activity data,” “replication data,” and “other business data.” It should be understood that the classification here in the present disclosure is merely illustrative, the data types may be classified according to actual business needs, and the present disclosure does not impose any limitation on this.

Then, the controller 306 may send the identified data to a logback appender 308. According to an example, the data collector 302 collects a data page containing 512 records from the customer system 304. After parsing, it is determined that 300 pieces of data therein are of the “activity” type and 212 pieces of data therein are of the “replication” type. The controller 306 can then send the two types of data to the logback appender 308 respectively.

According to some embodiments of the present disclosure, the logback appender 308 may be rewritten or redesigned to be able to send data to a plurality of different ports simultaneously, thereby achieving multi-channel output. Different types of data can be transmitted independently without interfering with each other on the same channel. As an embodiment of the present disclosure, the logback appender 308 may have a port mapping table, and the port mapping table has corresponding port information, such as a send port 8001 for activity data, a send port 8002 for replication data, and a send port 8003 for other business data. In some embodiments, when receiving data records input by the controller 306, the logback appender 308 may determine corresponding port information based on the data type, and send, through the port, the data to a subsequent processing module for processing. Additionally or alternatively, in some embodiments, the logback appender 308 may further encapsulate the data, such as converting the data into a structured JSON format, and appending metadata such as type, timestamp, and collection page information, for subsequent unpacking and processing.

According to some embodiments of the present disclosure, the data collector 302 may further include a plurality of buffer queues 310 for a plurality of data types. For example, the plurality of buffer queues may be queues dedicated to caching activity data, queues dedicated to caching replication data, queues dedicated to caching other business data, and so on. As an example, the size of the plurality of buffer queues may be set to 20480. In some embodiments, the plurality of buffer queues are accessed using a first-in-first-out principle to ensure the data consistency and security in a multi-threaded environment.

According to some embodiments of the present disclosure, the data collector 302 may further include a plurality of encapsulation processors 312 for the plurality of data types. According to some embodiments of the present disclosure, these encapsulation processors 312 may include one or more elements or components of batch processors (represented by “B” in the figure) and exporters (represented by “E” in the figure). According to some embodiments of the present disclosure, as an example, the encapsulation processor 312 may encapsulate or packetize the data into a batch in a unit of 512 records. The data streams have been cached in the plurality of buffer queues 310 by type, and therefore, the packetization is performed for the same type of data. Therefore, there will not be different types of data in the data packet. For a resource type with a large amount of data, the packet size may be 512. As a fully filled encapsulation, it improves the efficiency of processing and transmission. For example, this design ensures that no data of different resource types is mixed after encapsulation, thereby simplifying the downstream data processing and writing logic.

In some embodiments of the present disclosure, the encapsulation processor 312 may adopt two triggering mechanisms: using a timer or based on a data volume threshold. For example, when the data in the queue reaches 512 pieces, the encapsulation processor 312 may immediately perform data packetization. Additionally or alternatively, when the number of pieces does not reach 512 within a predetermined time (for example, 1 second), the encapsulation processor 312 may also perform a triggered packetization operation, thereby ensuring that the data does not remain in the queue for a long time.

According to some embodiments of the present disclosure, a plurality of concurrent pipeline queues may also be provided in a telemetry pipeline node 314 and a telemetry pipeline node 316 associated with the data collector 302, and the telemetry pipeline node may include corresponding receivers (represented by “R” in the figure), cache queues (represented by “Q” in the figure), batch processors (represented by “B” in the figure), and exporters (represented by “E” in the figure) for queues of a plurality of different data types (for example, pipeline queues for activity data, pipeline queues for replication data, and pipeline queues for other business data). Different types of resources can use different pipelines for data transmission. Each pipeline has its own unique port number to fully utilize the port and network bandwidth.

For example, in some embodiments of the present disclosure, the telemetry pipeline node 314 may be a first telemetry pipeline, and the telemetry pipeline node 314 may have a plurality of transmission ports and a plurality of transmission queues (such as activity queues, replication queues, and other business queues) respectively for transmission for a plurality of telemetry data types. According to some embodiments of the present disclosure, the telemetry pipeline node 316 may be a second telemetry pipeline, which may have a plurality of reception ports and a plurality of reception queues (such as activity queues, replication queues, and other business queues) respectively for reception for the plurality of telemetry data types from the telemetry pipeline node 314.

In some embodiments, as an example, the receivers in the telemetry pipeline node 314 and the telemetry pipeline node 316 can monitor the corresponding ports and receive the batch data from the encapsulation processor. In some embodiments, the received data can be validated and acknowledged within the pipeline, for example, verifying whether the amount of data in the batch meets an expectation, checking metadata integrity, and other operations, and then delivering the data to downstream modules or exporters.

According to some embodiments of the present disclosure, the data exporter 318 of the data center may receive data transmitted in by the telemetry pipeline node 314 and the telemetry pipeline node 316. According to an embodiment of the present disclosure, since a batch of data transmitted by each pipeline has been classified and transmitted during encapsulation, there is no need to unpack or reorder the batch internally through a controller at the data exporter, which reduces the need for additional judgment of mixed data and saves system processing time and corresponding computing resources.

According to some embodiments of the present disclosure, the data exporter 318 of the data center may pass the received data to a writer for processing. According to some embodiments of the present disclosure, the writer may be customized or redesigned. For example, a customized writer may call a predefined data model conversion program according to the data type, and convert the data of the same type into SQL batch insert statements and submit them to a database. The customized writer may also use batch processing technology to generate a plurality of SQL insert commands at a time, thereby reducing the number of database interactions and improving the writing efficiency. The method implemented according to the present disclosure can improve the transmission and storage efficiency by about dozens of times, and solve the problems of deadlock and data loss.

Some experimental data results are provided according to an embodiment of the present disclosure. Some experimental results show that the total amount of data that can be processed in a single batch can reach 6 million pieces. Some experimental results show the number of pieces of data for different resource types. Some experimental results show batch processing for each concurrent data pipeline. The maximum speed at which data is saved to the database is 7 k/s, and 90% of the data is written at 4 k/s. According to the method implemented in the embodiment of the present disclosure, the efficiency of collecting, transmitting, and storing millions of data can be improved by dozens of times, and the problems of deadlock and data loss can be solved. The data storage rate before the improvement is about 100 pieces per second, and there are problems of deadlock and data loss. According to the method implemented in the present disclosure, the data storage rate can be 4 k/second, and there is no deadlock or data loss.

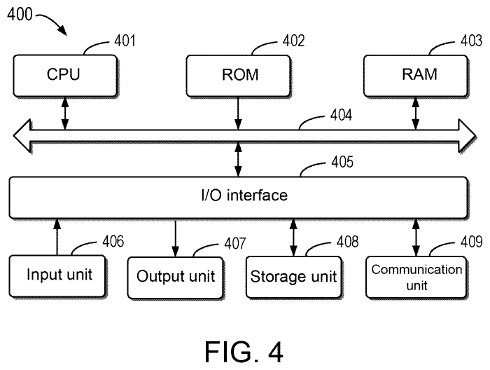

FIG. 4 shows a schematic block diagram of an example device 400 that may be configured to implement an embodiment of the present disclosure. The computing device in FIG. 1A can be implemented using the device 400. As shown in the figure, the device 400 includes a central processing unit (CPU) 401 that may execute various appropriate actions and processing according to computer program instructions stored in a read-only memory (ROM) 402 or computer program instructions loaded from a storage unit 408 to a random access memory (RAM) 403. Various programs and data required for operations of the device 400 may also be stored in the RAM 403. The CPU 401, the ROM 402, and the RAM 403 are connected to each other through a bus 404. An input/output (I/O) interface 405 is also connected to the bus 404.

A plurality of components in the device 400 are connected to the I/O interface 405, including: an input unit 406 such as a keyboard and a mouse; an output unit 407, such as various types of displays and speakers; a storage page 408, such as a magnetic disk and an optical disc; and a communication unit 409, such as a network card, a modem, and a wireless communication transceiver. The communication unit 409 allows the device 400 to exchange information/data with other devices via a computer network, such as the Internet, and/or various telecommunication networks.

The various processes and processing described above, such as the method 200, may be performed by the processing unit 401. For example, in some embodiments, the method 200 may be implemented as a computer software program that is tangibly included in a machine-readable medium such as the storage unit 408. In some embodiments, part of or all the computer program may be loaded and/or installed onto the device 400 via the ROM 402 and/or the communication unit 409. When the computer program is loaded to the RAM 403 and executed by the CPU 401, one or more actions of the method 200 described above may be implemented.

The present disclosure may be a method, apparatus, system, and/or computer program product. The computer program product may include a computer-readable storage medium on which computer-readable program instructions for performing various aspects of the present disclosure are loaded.

The computer-readable storage medium may be a tangible device that may hold and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any appropriate combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, status setting data, or source code or object code written in any combination of one or more programming languages, the programming languages including object-oriented programming languages, such as Smalltalk and C++, as well as conventional procedural programming languages, such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described here with reference to flow charts and/or block diagrams of the method, the apparatus (system), and the computer program product implemented according to the embodiments of the present disclosure. It should be understood that each block of the flow charts and/or block diagrams and combinations of blocks in the flow charts and/or block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the systems, methods, and computer program products according to a plurality of embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a special hardware-based system that executes specified functions or actions, or using a combination of special hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The selection of terms as used herein is intended to best explain the principles and practical applications of the various embodiments or technical improvements to technologies on the market, or to enable other persons of ordinary skill in the art to understand the embodiments disclosed here.

1. A method for transmitting telemetry data, comprising:
receiving telemetry data from a client, wherein the telemetry data is used to monitor a status of the client;
classifying, based on a plurality of telemetry data types, the telemetry data into a plurality of buffer queues for the plurality of telemetry data types; and
transmitting the classified telemetry data in parallel via the plurality of buffer queues for the plurality of telemetry data types.

2. The method according to claim 1, wherein receiving the telemetry data from the client comprises:
collecting the telemetry data in data pages from the client in parallel by a data collector through a plurality of threads for each telemetry data type of the plurality of telemetry data types.

3. The method according to claim 2, wherein receiving the telemetry data from the client further comprises:
receiving, by a logback appender in the data collector, the telemetry data collected from the plurality of threads.

4. The method according to claim 3, wherein the logback appender comprises a plurality of send ports for the plurality of telemetry data types, and wherein classifying, based on the plurality of telemetry data types, the telemetry data into the plurality of buffer queues for the plurality of telemetry data types comprises:
sending the telemetry data to the plurality of buffer queues for the plurality of telemetry data types based on the plurality of telemetry data types and via the plurality of send ports for the plurality of telemetry data types in the logback appender, to classify the telemetry data.

5. The method according to claim 4, wherein the data collector further comprises an encapsulation processor, and wherein transmitting the classified telemetry data via the plurality of buffer queues for the plurality of telemetry data types comprises:
encapsulating, by the encapsulation processor, the classified telemetry data in the plurality of buffer queues based on the plurality of telemetry data types; and
transmitting the encapsulated telemetry data to a first telemetry pipeline, wherein the encapsulated telemetry data has the same data type and has a fixed size.

6. The method according to claim 5, wherein the first telemetry pipeline has a plurality of transmission ports and a plurality of transmission queues respectively for transmission for the plurality of telemetry data types.

7. The method according to claim 6, wherein the first telemetry pipeline is configured to transmit the encapsulated telemetry data to a data exporter associated with a database through the plurality of transmission ports and the plurality of transmission queues for the plurality of telemetry data types.

8. The method according to claim 7, wherein the data exporter further comprises a second telemetry pipeline associated with the data exporter, and wherein the second telemetry pipeline has a plurality of reception ports and a plurality of reception queues respectively for reception for the plurality of telemetry data types.

9. The method according to claim 8, wherein the second telemetry pipeline is configured to receive the encapsulated telemetry data from the first telemetry pipeline associated with the data collector through the plurality of reception ports and the plurality of reception queues for the plurality of telemetry data types.

10. The method according to claim 8, wherein the data exporter further comprises a writer configured to convert the received encapsulated telemetry data into insert statements of a structured query language (SQL) in batches, so as to be written into the database.

11. The method according to claim 1, wherein the telemetry data of the plurality of telemetry data types in the plurality of buffer queues comprises one or more of the following:
telemetry data associated with user activity;
telemetry data associated with replication; or telemetry data associated with other businesses.

12. A system for transmitting telemetry data, comprising:
a processor; and
a memory coupled to the processor and storing instructions, wherein the instructions, when executed by the processor, cause the system to perform the following actions:
receiving telemetry data from a client, wherein the telemetry data is used to monitor a status of the client;
classifying, based on a plurality of telemetry data types, the telemetry data into a plurality of buffer queues for the plurality of telemetry data types; and
transmitting the classified telemetry data in parallel via the plurality of buffer queues for the plurality of telemetry data types.

13. The system according to claim 12, wherein receiving the telemetry data from the client comprises:
collecting, by the system, the telemetry data in data pages from the client in parallel by a data collector through a plurality of threads for each telemetry data type of the plurality of telemetry data types.

14. The system according to claim 13, wherein receiving the telemetry data from the client further comprises:
receiving, by a logback appender in the data collector, the telemetry data collected from the plurality of threads.

15. The system according to claim 14, wherein the logback appender comprises a plurality of send ports for the plurality of telemetry data types, and wherein classifying, based on the plurality of telemetry data types, the telemetry data into the plurality of buffer queues for the plurality of telemetry data types comprises:
sending the telemetry data to the plurality of buffer queues for the plurality of telemetry data types based on the plurality of telemetry data types and via the plurality of send ports for the plurality of telemetry data types in the logback appender, to classify the telemetry data.

16. The system according to claim 15, wherein the data collector further comprises an encapsulation processor, and wherein transmitting the classified telemetry data via the plurality of buffer queues for the plurality of telemetry data types comprises:
encapsulating, by the encapsulation processor, the classified telemetry data in the plurality of buffer queues based on the plurality of telemetry data types; and
transmitting the encapsulated telemetry data to a first telemetry pipeline, wherein the encapsulated telemetry data has the same data type and has a fixed size.

17. The system according to claim 16, wherein the first telemetry pipeline has a plurality of transmission ports and a plurality of transmission queues respectively for transmission for the plurality of telemetry data types.

18. The system according to claim 17, wherein the first telemetry pipeline is configured to transmit the encapsulated telemetry data to a data exporter associated with a database through the plurality of transmission ports and the plurality of transmission queues for the plurality of telemetry data types.

19. The system according to claim 18, wherein the data exporter further comprises a second telemetry pipeline associated with the data exporter, and wherein the second telemetry pipeline has a plurality of reception ports and a plurality of reception queues respectively for reception for the plurality of telemetry data types.

20. A computer program product tangibly stored on a non-transitory computer-readable storage medium and comprising computer-executable instructions, wherein the computer-executable instructions, when executed, cause a computer to perform the following:
receiving telemetry data from a client, wherein the telemetry data is used to monitor a status of the client;
classifying, based on a plurality of telemetry data types, the telemetry data into a plurality of buffer queues for the plurality of telemetry data types; and
transmitting the classified telemetry data in parallel via the plurality of buffer queues for the plurality of telemetry data types.
